(19) United States
(12) Patent Application Publication
(10) Pub. No.: US 2013/0255272 A1
(43) Pub. Date: Oct. 3, 2013

(54) METHOD FOR CARBON CAPTURE IN A GAS TURBINE BASED POWER PLANT USING CHEMICAL LOOPING REACTOR SYSTEM

(71) Applicants: Marc Ajhar, Wiesbaden (DE); Gerhard Heinz, Esslingen (DE); Olaf Stallmann, Essenheim (DE); Gian-Luigi Agostinelli, Zurich (CH)

(72) Inventors: Marc Ajhar, Wiesbaden (DE); Gerhard Heinz, Esslingen (DE); Olaf Stallmann, Essenheim (DE); Gian-Luigi Agostinelli, Zurich (CH)

(73) Assignee: ALSTOM TECHNOLOGY LTD., Baden (CH)

(21) Appl. No.: 13/435,598

(22) Filed: Mar. 30, 2012

(51) Int. Cl. F02C 3/20; F23L 7/00; F23L 99/00; F01K 23/10

(52) U.S. Cl. 60/780; 60/39.12; 60/39.182; 60/726; 60/772

(57) ABSTRACT

Disclosed herein is a system comprising an air reactor; where the air reactor is operative to oxidize metal oxide particles with oxygen from air to form oxidized metal oxide particles; a fuel reactor; where the fuel reactor is operative to release the oxygen from the oxidized metal oxide particles and to react this oxygen with fuel and steam to form syngas; a water gas shift reactor located downstream of the fuel reactor; where the water gas shift reactor is operative to convert syngas to a mixture of carbon and hydrogen; a combustor; and a gas turbine; the combustor being operative to combust the hydrogen and discharge flue gases derived from the combustion of hydrogen to drive the turbine; where the exhaust from the turbine is carbon free.

### TECHNICAL FIELD

This disclosure relates to a method for carbon capture in a gas turbine based power plant involving chemical looping for fuel processing.

### BACKGROUND

Gas turbine based power generation is an efficient method for power generation to achieve high electric yields of about 60%. Combined cycle power plants that use gas turbines are often used to generate electrical power. In a combined cycle power plant, natural gas is burned with air in a gas turbine and the exhaust gas is used to heat steam that is fed to a steam turbine. Although this type of power plant is efficient in terms of electricity production, one of its chief disadvantages is that it is restricted to gaseous and liquid fuels and the combustion with air makes the capture of carbon dioxide more difficult than in oxygen fired systems. The negative environmental effects of releasing carbon dioxide to the atmosphere have been recognized, and have resulted in the development of processes adapted to removing or reducing the amount of carbon dioxide from the flue gas streams.

There are three approaches to capturing carbon dioxide. One approach involves pre-combustion where the fuel is decarbonized prior to the main combustion phase in the power plant. This method has several drawbacks. These involve an energy penalty during the pre-combustion phase and the high auxiliary energy consumption of the air separation unit especially when oxygen is used during gasification.

Another approach involves oxy-combustion where an oxygen rich stream is used in the combustion instead of air and the flue gas resulting from combustion contains a high percentage of carbon dioxide, which is easier to separate from the flue gases.

Yet another approach comprises post combustion where the carbon dioxide is removed from the flue gas after combustion. This method involves removing the carbon dioxide from the flue gas stream using a chilled ammonia process or an amine solvent removal process. This method has several drawbacks—notably that the low carbon dioxide concentration in the flue gas stream necessitates a large effort to capture the carbon dioxide. In the amine solvent capture process, for example, the energy demand needed for the regeneration of solvent to release the carbon dioxide reduces the amount of energy generated and increases the cost of energy generated.

Each of these methods has certain drawbacks. It is therefore desirable to devise a gas turbine based power generation process in combination with a method for carbon capture that overcomes some of these drawbacks.

### SUMMARY

Disclosed herein is a system comprising an air reactor; where the air reactor is operative to oxidize metal oxide particles with oxygen from air to form oxidized metal oxide particles; a fuel reactor; where the fuel reactor is operative to release the oxygen from the oxidized metal oxide particles and to react this oxygen with fuel and steam to form syngas; a water gas shift reactor located downstream of the fuel reactor; where the water gas shift reactor is operative to convert syngas to a mixture of carbon and hydrogen; a combustor; and a gas turbine; the combustor being operative to combust the hydrogen and discharge flue gases derived from the combustion of hydrogen to drive the turbine; where the exhaust from the turbine is carbon free.

Disclosed herein is a method comprising discharging oxidized metal oxide particles from an air reactor to a fuel reactor; dissociating oxygen from the oxidized metal oxide particles; reacting oxygen and steam with fuel in a fuel reactor to produce syngas; converting carbon monoxide from the syngas into carbon dioxide in a water gas shift reactor; separating hydrogen from the carbon dioxide; combusting hydrogen in a combustor to produce carbon free flue gas; and discharging the carbon free flue gas to a gas turbine to generate energy.

### BRIEF DESCRIPTION OF THE FIGURES

FIG. 1 depicts an exemplary system for effecting carbon capture prior to combustion in the turbine.

### DETAILED DESCRIPTION

Disclosed herein is a system and a method that facilitates carbon capture in a facility where power is generated for public consumption (e.g.; electricity) or for use in another manufacturing industry (e.g., manufacturing of glass, cement, and the like). The system advantageously comprises using chemical looping to facilitate pre-combustion carbon dioxide capture. The system advantageously uses chemical looping to produce syngas for combustion.

In an exemplary embodiment, primary metal oxide particles (hereinafter termed “reduced oxygen carrier”) exothermically bind the oxygen present in air that is charged to an air reactor to form secondary metal oxide (hereinafter termed “oxidized oxygen carrier”) particles.

These oxidized oxygen carrier particles are discharged to a fuel reactor, where a fuel is first gasified with fluidization steam and the oxygen that is released from the oxidized oxygen carrier particles reacts with coal and small amounts of gasification products supplying heat energy. The fuel reactor converts the fuel into mainly syngas (hydrogen and carbon monoxide), water vapor and carbon dioxide. The syngas along with the water vapor and carbon dioxide is then discharged to a water shift reactor, where most of the carbon monoxide is converted to carbon dioxide in the water gas shift reaction. The carbon dioxide and the hydrogen emanating from the water gas shift reactor are then discharged to a filtration system where the carbon dioxide is separated out and sequestered while the hydrogen is burnt in a gas turbine combustor. The separated hydrogen is burnt with ambient air or with a mixture of oxygen depleted air obtained from the air reactor.

Using oxygen depleted air has a number of advantages most notably a reduction in the formation of nitrogen oxides (NOx). The exhaust gas from the gas turbine is substantially carbon dioxide free. The hot exhaust gas is used to provide heat to a steam cycle that drives a steam turbine.

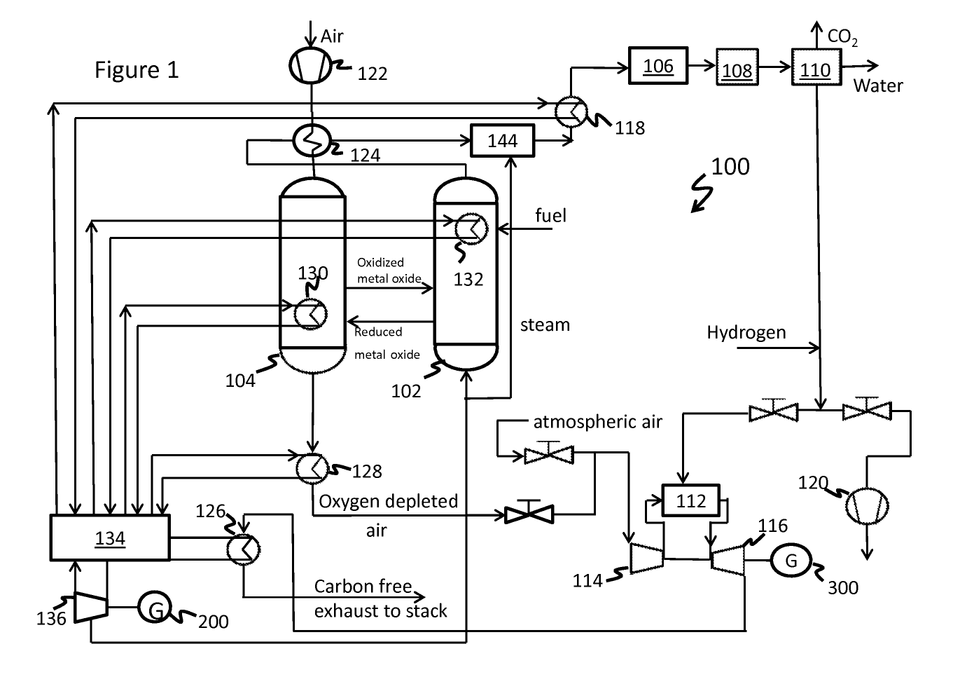

With reference now to the FIG. 1, a system 100 for carbon capture in a combined cycle power plant comprises a fuel reactor 102 and an air reactor 104 in a recycle loop with each other. A water gas shift reactor 106 is located downstream of the fuel reactor 102. A combustion system comprising a compressor 114, a combustor 112 and a turbine 116 are located downstream of the air reactor 104. A steam turbine 136 operating on a steam cycle lies downstream of the turbine 116.

In one embodiment, in one method of operating the system 100 of the FIG. 1, reduced oxygen carrier particles combine with oxygen from air charged into the fuel reactor 102 to produce oxidized oxygen carrier particles which have a higher molar ratio of oxygen to metal than the molar ratio of oxygen to metal in the reduced oxygen carrier particles. Air is charged into the air reactor 104 via a fan or compressor 122 and heat exchanger 124. The oxygen carrier particles are typically metallic or ceramic. Typical metal oxides used in chemical looping include nickel oxide, calcium oxide, iron oxide, copper oxide, manganese oxide, cobalt oxide, or the like, or a combination comprising at least one of the foregoing metal oxides.

The oxidized oxygen carrier particles are discharged to the fuel reactor 102. In the fuel reactor 102, an incoming stream of fuel is gasified with fluidization steam and oxygen released from the oxidized oxygen carrier particles to produce syngas. The steam for the fuel reactor 104 may be supplied from a variety of different sources. After releasing their oxygen in the fuel reactor 102, the oxidized oxygen carrier particles become reduced oxygen carrier particles and are recycled to the air reactor 104 to absorb more oxygen from the incoming air stream.

The fuel supplied to the fuel reactor 102 can be in either the gaseous, liquid or solid state. Examples of fuels are natural gas, ethane, propane, diesel, gasoline, oil, coal, peat, waste, and the like, or a combination comprising at least one of the foregoing fuels. An exemplary fuel for use in the system 100 is coal.

Exothermal oxygen consumption (in the fuel reactor 102) assures an autothermal operation of the fuel reactor 102 so that no external heat is added to this reactor. However, depending on operating conditions, the fuel reactor can be endothermal or exothermal. The latter could involve removing heat energy via heat exchange 132. In one embodiment, the fuel reactor 102 operates at a temperature of about 750 to about 1050° C., specifically about 800 to about 1000° C., and more specifically about 950° C.

Both the air reactor 104 and the fuel reactor 102 are in fluid communication with heat exchangers 130 and 132 respectively that are operative to heat steam for the steam heat exchanger 134 and the steam turbine 136 in the steam cycle.

The gasification of the fuel in the fuel reactor 102 results in the production of syngas (mainly carbon monoxide and hydrogen), water vapor and carbon dioxide. The syngas along with the water vapor and the carbon dioxide is then discharged to the water gas shift reactor 144 where the carbon monoxide is converted to carbon dioxide in a water gas shift reaction. The mixture of carbon dioxide and hydrogen obtained in the water gas shift reactor 144 is then discharged to a heat exchanger 118, where the hot carbon dioxide and hydrogen exchange their heat with water that is used in the steam turbine 136 in the steam cycle.

The mixture of carbon dioxide and hydrogen are then sent to an flue gas treatment system 106 and to one or more devices (108, 110) for purification and for separation of the hydrogen from the carbon dioxide.

The flue gas treatment system 106 is optional depending on the fuel used and is used to remove dust and/or sulfur from the mixture of carbon dioxide and hydrogen. The devices for separating the hydrogen from the carbon dioxide are collectively depicted by the reference numeral 108 in the FIG. 1. The devices may include a pressure swing adsorption device, where some gas species are separated from a mixture of gases under pressure according to the species' molecular characteristics and affinity for an adsorbent material. These devices may also include membranes, which can separate hydrogen molecules from carbon dioxide molecules.

Further separation of the hydrogen from carbon dioxide and water vapor may be accomplished in the gas processing unit 110. The gas processing unit purifies and compresses the carbon dioxide for transportation and sequestration. Typically, carbon dioxide is liquefied, resulting in hydrogen concentration in the gas phase. Moreover, water is retrieved from the gas processing unit and may be recharged to the steam cycle (not shown). The carbon dioxide may be shipped off for sequestration of may alternatively be used in other useful chemical processes such as the foaming of plastics.

The hydrogen that is separated from the mixture of carbon dioxide and water is then discharged to the combustor 112, where it is combusted with compressed oxygen depleted air (obtained from the air reactor 104) or compressed air (derived from the atmosphere). Additional commercially available hydrogen may be added to the hydrogen stream obtained after the purification process prior to combustion in the combustor 112. The oxygen depleted air is derived from the air reactor 104 and first transfers excess heat to water in a heat exchanger 128. It is used in the steam cycle, driving a steam turbine 136 connected to a first generator 200. A condenser 120 lies downstream of a gas processing unit 110 can be used to condense any hydrogen that is not combusted.

The oxygen depleted air or air derived from the atmosphere is first compressed in a compressor 114 before it is supplied to the combustor 112 to produce carbon free flue gases which are discharged to drive a turbine 116, where it drives a second generator 300. The carbon free flue gases are then discharged to the exterior via a flue stack.

The carbon free flue gases derived from the combustor 112 and turbine 116 are then discharged to a heat exchanger 126 where they exchange their heat with the steam that is used to operate the steam cycle for the steam turbine 136 and the heat exchanger 134. In the steam cycle, water that is converted to steam in the heat exchangers 118, 124, 126, 128, 130 and 132 is collected in a heat exchanger unit 134 and used to drive the steam turbine 136. The steam turbine 136 is coupled with the second steam generator 300 to generate electricity.

Certain amounts of steam may be extracted from the steam turbine 136 for use in the fuel reactor 102 as a fluidization medium and as reactant in the water gas shift reactor 144. As an alternative to combustion in 112, for example during periods of low electricity prices, the hydrogen can be stored in a tank or in a grid. In this case, the gas turbine is switched off, but the steam cycle system (including the turbine 136) operates at partial load in order to maintain cooling of the chemical looping reactors. In this scenario, carbon dioxide removal in the gas processing unit 110 would also remain continuous.

This system is advantageous in that it facilitates easy and efficient carbon dioxide capture. There are no carbon emissions from the gas turbine. In comparison to burning natural gas in the turbine, the carbon dioxide capture is not a post-combustion, but a pre-combustion capture technique.

This method allows of the use of solid fuels and not just liquid and gaseous fuels. The combined cycle power plant is one of the most efficient power plant processes in terms of energy yield. The system disclosed herein is advantageous in that it permits the use of inexpensive gasified fuel such as coal. The concept is robust and adaptable in that it can be used in an identical manner for any type of fuel produced.

Chemical looping fuel reactors used in combustion applications still suffer from containing high amounts of unburnt fuel in the flue gas. This circumstance is an advantage in this invention. The oxygen supply to the fuel reactor is under stoichiometric in order to produce syngas. All fuel in this process is predominantly converted to carbon dioxide and hydrogen after the water gas shift reaction. Any fuel that does not get burned in the fuel reactor is burned in the combustor.

In comparison to other gasifiers that must be operated with expensively produced oxygen from a cryogenic air separation unit (ASU), thermodynamically, oxygen supply via chemical looping generally consumes the same energy amounts as it sets free and is therefore more cost-efficient.

Equipped with a means for hydrogen storage, the method disclosed herein is well suited to store the produced hydrogen until the electricity demand/price rises. The chemical looping reactors and the GPU system will run continuously regardless of the chosen operating mode (gas turbines and hydrogen storage). The method and system disclosed herein are therefore comparably “flexible” as stand-alone gas turbines running on natural gas. The use of oxygen-depleted air in a mixture with ambient air for combustion in the gas turbine is beneficial for NOₓ-control and facilitates the combustion of hydrogen.

It will be understood that, although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, “a first element,” “component,” “region,” “layer” or “section” discussed below could be termed a second element, component, region, layer or section without departing from the teachings herein.

The terminology used herein is for the purpose of describing particular embodiments only and is not intended to be limiting. As used herein, the singular forms “a,” “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another elements as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower,” can therefore, encompasses both an orientation of “lower” and “upper,” depending on the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Exemplary embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

The term and/or is used herein to mean both “and” as well as “or”. For example, “A and/or B” is construed to mean A, B or A and B.

The transition term “comprising” is inclusive of the transition terms “consisting essentially of” and “consisting of” and can be interchanged for “comprising”.

While this disclosure describes exemplary embodiments, it will be understood by those skilled in the art that various changes can be made and equivalents can be substituted for elements thereof without departing from the scope of the disclosed embodiments. In addition, many modifications can be made to adapt a particular situation or material to the teachings of this disclosure without departing from the essential scope thereof. Therefore, it is intended that this disclosure not be limited to the particular embodiment disclosed as the best mode contemplated for carrying out this disclosure.

What is claimed is:

1. A system comprising:
an air reactor; where the air reactor is operative to oxidize metal oxide particles with oxygen from air to form oxidized metal oxide particles;
a fuel reactor; where the fuel reactor is operative to release the oxygen from the oxidized metal oxide particles and to react this oxygen with fuel and steam to form syngas;
a water gas shift reactor located downstream of the fuel reactor; where the water gas shift reactor is operative to convert syngas to a mixture of carbon and hydrogen;
a combustor; and
a gas turbine; the combustor being operative to combust the hydrogen and discharge flue gases derived from the combustion of hydrogen to drive the turbine; where the exhaust from the turbine is carbon free.

2. The system of claim 1, further where the air reactor and the fuel reactor are in a recycle loop with each other and wherein the oxidized metal oxide particles are transported from the air reactor to the fuel reactor, and reduced metal oxide particles are transported from the fuel reactor to the air reactor.

3. The system of claim 1, further comprising a steam turbine, the steam turbine being in fluid communication with a heat exchanger that receives flue gases from the gas turbine.

4. The system of claim 3, where the steam turbine operates on the steam cycle.

5. The system of claim 3, where the steam turbine receives steam from heat exchangers that are in fluid communication with the air reactor and the fuel reactor.

6. The system of claim 1, further comprising a gas processing unit disposed downstream of the water gas shift reactor; where the gas processing unit is operative to separate carbon dioxide from the hydrogen.

7. The system of claim 1, further comprising a compressor, the compressor receiving oxygen depleted air from the air reactor and supplying compressed air to a combustor.

8. The system of claim 7, where the compressor receives ambient air in addition to oxygen depleted air.

9. The system of claim 1, where the fuel reactor receives steam from a steam turbine; the steam being used as a fluidization medium in the fuel reactor.

10. A method comprising:
discharging oxidized metal oxide particles from an air reactor to a fuel reactor;
dissociating oxygen from the oxidized metal oxide particles;
reacting oxygen and steam with fuel in a fuel reactor to produce syngas;
converting carbon monoxide from the syngas into carbon dioxide in a water gas shift reactor;
separating hydrogen from the carbon dioxide;
combusting hydrogen in a combustor to produce carbon free flue gas; and
discharging the carbon free flue gas to a gas turbine to generate energy.

11. The method of claim 10, further comprising discharging the carbon free flue gas to a heat exchanger; where it exchanges its heat with water that is used in a steam turbine to generate energy.

12. The method of claim 10, further comprising compressing oxygen depleted air received from the air reactor and discharging it to a combustor where the oxygen depleted air is combusted with the hydrogen.

13. The method of claim 10, further comprising discharging reduced metal oxide particles from the fuel reactor to the air reactor.

14. The method of claim 10, further comprising discharging steam from a steam turbine to the fuel reactor to serve as a fluidization medium in the fuel reactor.

15. The method of claim 12, further comprising supplying ambient air to the compressor.

16. The method of claim 11, further comprising supplying steam from heat exchangers in fluid communication with the fuel reactor and the air reactor to the steam turbine.

17. The method of claim 16, where the steam turbine operates on the steam cycle.
